(19) United States
(12) Patent Application Publication
(10) Pub. No.: US 2014/0032552 A1
(43) Pub. Date: Jan. 30, 2014

(54) DEFINING RELATIONSHIPS

(71) Applicants: Ira Cohen, Modiin (IL); Ruth Bernstein, Kiryat Ono (IL); Yonatan Ben Simhon, Netanya (IL)

(72) Inventors: Ira Cohen, Modiin (IL); Ruth Bernstein, Kiryat Ono (IL); Yonatan Ben Simhon, Netanya (IL)

(21) Appl. No.: 13/561,255

(22) Filed: Jul. 30, 2012

(51) Int. Cl. G06F 17/30

(52) U.S. Cl. 707/737; 707/E17.046

(57) ABSTRACT

Defining relationships are described. Defining relationships can include retrieving a number of event notifications that correspond to a number of nodes. Defining relationships can include defining a number of group patterns that correspond to the number of event notifications. Defining relationships can also include grouping the number of nodes into a number of groups that correlate with the number of group patterns, the number of groups defining a number of relationships between the number of nodes. Defining relationships can include assigning a number of weights to the number of relationships between the number of nodes, wherein the number of weights are based on a strength of the number of relationships between the number of nodes.

### BACKGROUND

Management tools can assist a user in managing a number of servers. For example, management tools can assist a user in configuring a number of servers. Management tools can inform a user when a number of errors have been detected in the number of servers. Determining the source of an error can assist a user in finding a solution for the error.

### BRIEF DESCRIPTION OF THE DRAWINGS

FIG. 1 is a flow chart illustrating an example of a method for defining relationships according to the present disclosure.

FIG. 2 is a flow chart illustrating an example of a method for defining relationships through a weighted graph according to the present disclosure.

FIG. 3 is a diagram illustrating an example of a weighted graph according to the present disclosure.

FIG. 4 illustrates an example computing device according to the present disclosure.

### DETAILED DESCRIPTION

A topological view of a number of systems can aid a user that manages the number of systems. A topological view can include the systems, e.g., nodes, and a number of relationships between the systems, e.g., links and/or edges. In many instances, a topological view of a number of systems may be incomplete and/or unavailable. In a number of examples of the present disclosure, a topological view of a number of systems can be created from a number of event notifications that are created by a number of systems.

Previous approaches to finding a number of relationships between a number of systems include a set of static rules. For example, a first system can be asked who the first system depends from and with what other systems the first system communicates. However, there may be a number of relationships and/or dependencies that can exist between a number of systems that may not be evident by following a number of static rules.

A topological view of a number of systems can comprise of a graph that illustrates a number of relationships between the number of systems. A graph can represent the number of systems as nodes, and the number of relationships can be represented as links and/or edges. A graph can allow a user that manages a number of systems to identify a number of dependencies that might have been missed using a set of static rules.

As used herein, a node and/or a system can be a computational component. A node can include logical components and physical components. For example, a physical component can be a server, a router, and/or a handheld electronic device, among others. A logical component can be machine readable instructions (MRI), a database, and/or a web browser, among others. In a number of examples of the present disclosure, a computational component can generate a number of event notifications and/or messages that can be communicated through a network.

An event notification can include a message that conveys the state of a node. For example, an event notification can be an alert that expresses a failure in a node, e.g., computational component. An alert can be a fail alert, e.g., abnormal event notification, such that when a failure occurs in a component an alert can be generated. An alert can be a message that expresses that a warning. An event notification can be a message that informs a user that the state of a node has changed. For example, an event notification can be generated when a storage device is plugged into a server.

An event notification can originate at a node and can be stored at a number of locations. For example, an event notification can be stored at a node from which it originated, at a central server, and/or in a database. An event notification can include a timestamp. The timestamp can express a specific time at which the state of a corresponding node changed. For example, a timestamp can indicate that a failure occurred at a specific time. The storage of an alert can include the storage of an associated timestamp.

A number of relationships between a number of nodes can express a number of dependencies. For example, a first node can depend from a second node such that a change in a state of the second node can create a change in a state of the first node. A dependency can include physical dependency, a resource dependency, and/or a number of other types of dependencies. A physical dependency, for example, can include a dependency that a logical component can have on a physical component. A resource dependency, for example, can include a dependency that a first logical component can have on a second logical component and/or a physical component can have on a logical component. A number of nodes can reside in a location and/or at a number of locations. For example, a first node and a second node can reside in a server or can reside in a number of servers. A dependency between a number of nodes can include a one-to-one dependency and/or a many-to-one dependency, among types of dependencies.

A one-to-one dependency, for example, can include a dependency that a website has on a server that hosts the website. If a hosting server experiences a failure, such that the server is shut down, then the website can also experience a failure. A many-to-one dependency, for example, can include a dependency that a first node has on a number of nodes combined such that a number of event can occur in the number of nodes before the first node can create an event notification.

A dependency between a first node and a third node can be a direct dependency, and/or it can be an indirect dependency. For example, an indirect dependency can include a dependency between a first node and a third node wherein the first node can depend from a second node that can depend from the third node such that a failure in the third node can trigger a failure in the second node which can trigger a failure in the first node. A number of dependencies may not always be evident and can include a number of intricate patterns of dependencies. Furthermore, a dependency can vary. For example, a first node can depend on a second node but only if a third node is not active. That is, the number of dependencies can be dynamically linked such that they can change and/or mutate over time.

A number of links can express a number of relationships, e.g., dependencies, between a number of nodes on a graph. A link can include a conceptual connection and can be expressed in a number of ways in a graph.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

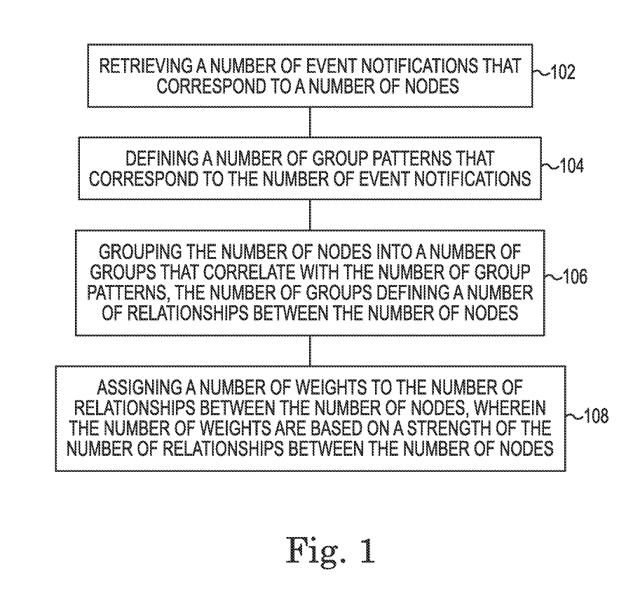

FIG. 1 is a flow chart illustrating an example of a method for defining relationships according to the present disclosure. At 102, a number of event notification can be retrieved, wherein the number of notifications can correspond to a number of nodes. A number of event notifications can be collected e.g., stored, over a time period. A number of event notifications that are collected over a time period can constitute historical data that can express a number of relationships between a number of nodes that created the number of event notifications.

At 104, a number of group patterns can be defined, wherein the number of group patterns can correspond to a number of event notifications. A group pattern can be a pattern in which a number of event notifications are created. For example, a pattern can include a number of event notifications that occur at the same time and/or at substantially the same time. For example, Table 1 shows an example of a number of event notifications. Table 1 includes number of components, a number of time intervals, and a number of notifications.

A number of components can include a first server, e.g., Server1, a second server, e.g., Server2, a database, a web server, and a router. A number of time intervals can include a first time interval, e.g., t1, a second time interval, e.g., t2, a third time interval, e.g., t3, a fourth time interval, e.g., t4, a fifth time interval, e.g., t5, a sixth time interval, e.g., t6, a seventh time interval, e.g., t7, an eighth time interval, e.g., t8, a ninth time interval, e.g., t9, and a tenth time interval, e.g., t10. Each of the “1” represents an event notification at a specific time interval. For example, a server can have created an event notification at a second time interval, a third time interval, a fifth time interval, an eighth time interval, and a ninth time interval. If a group pattern includes a number of event notifications that occur at the same time, then a group pattern can include the notifications created by the first server, the second server, and the database at a second time interval, among others.

A group pattern can include a particular sequence of event notifications. For example, as shown in Table 1, a group pattern can include a number of event notifications created by a first server, a second server, and a database at a second time interval and a third time interval followed by an event notification created by a web server at a fourth time interval. The group pattern can also be found in the number of event notifications created by the first server, the second server, and the database at an eighth time interval and a ninth time interval followed by an event notification created by the web server at a tenth time interval. A number of tools and/or methods can be used to find a number of group patterns from a number of event notifications.

TABLE 1
Example of a Number of Event Notifications

| | t1 | t2 | t3 | t4 | t5 | t6 | t7 | t8 | t9 | t10 |
|---|---|---|---|---|---|---|---|---|---|---|
| Server1 | | 1 | 1 | | 1 | | | 1 | 1 | |
| Server2 | | 1 | 1 | | | | | 1 | 1 | |
| Database | | 1 | 1 | | | | 1 | 1 | 1 | |
| Web Server | | | | 1 | | | 1 | | | 1 |
| Router | | | | | | 1 | | | | |

A number of group patterns can express a number of dependencies between a number of nodes that created the number of event notifications. For example, as shown in Table 1, a group pattern that includes a number of event notifications created by a first server, a second server, and a database can express a number of dependencies, e.g., relationships, between the first server, the second server, and the database.

At 106, a number of nodes can be grouped into a number of groups that correlate with a number of group patterns, the number of groups defining a number of relationships between the number of nodes. For example, if a group pattern includes a number of event notifications created by a first server, a second server and a database, as seen in Table 1, then a group can include the first server, the second server, and the database. A number of groups can define a number of relationships between a number of nodes. That is, a group can define a number of dependencies between a number of nodes in a group.

At 108, a number of weights can be assigned to the number of relationships between the number of nodes, wherein the number of weights can be based on a strength of the number of relationships between the number of nodes. Each of a number of relationships can be assigned a weight. For example, a group consisting of a first node, a second node, and a third node can include a first relationship between the first node and the second node, a second relationship between the first node and the third node, and a third relationship between the second node and the third node. Each of a number of relationships can have an associated strength. For example, a first node can have a stronger relationship with a second node than with a third node. The strength of a relationship can be based on a number of factors including an associated group pattern and/or a number of notifications that are associated with the two nodes in a relationship. For example, as seen in Table 1, a first server and a second server can have a stronger relationship than a relationship between the first server and a web server because a number of event notifications that the first server and the second server created can have a greater correlation than a number of notifications that the first server and the web server created. That is, a strength of a relationship between a first node and a second node can be associated with the correlation between a first number of event notifications that the first node generates and a second number of event notifications that the second node generates.

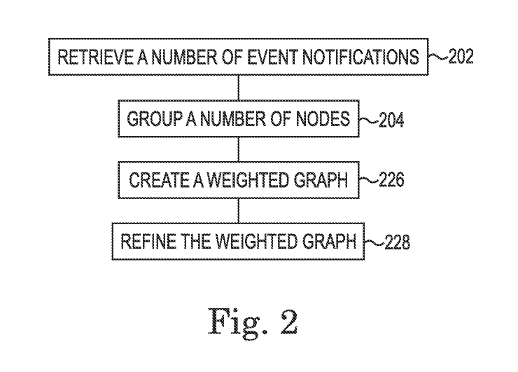

FIG. 2 is a flow chart illustrating an example of a method for defining relationships through a weighted graph according to the present disclosure. At 202, a number of event notifications can be retrieved. A number of event notifications can include a number of time stamps that can be used to associate the number of event notification. A number of correlations between a number of event notifications can be used to find a number of relationships between a number of nodes that created the number of event notifications.

At 204, a number of nodes can be grouped into a number of groups that define the existence of a number of relationships. Grouping a number of nodes can include identifying a number of group patterns associated with the number of nodes. A number of nodes can be grouped a number of event notifications are correlated. That is, event notifications that occur at the same time interval and/or at substantially the same time interval can be grouped.

Creating a number of groups of event notifications can include linking the number of event notifications. A link can represent the existence of a relationship between two nodes such that a link connects two nodes. For example, a link can be created between a first node and a second node. Two nodes can have a plurality of links between each other when the links correspond to a plurality of separate dependencies between the two nodes. For example, a first link can exist between a first node and a second node to denote a first dependency wherein the first node and the second node are part of a first group. A second link can also exist between the first node and the second node to denote a second dependency that can be different from the first dependency, wherein the first node and the second node are part of a second group.

At 226, a weighted graph can be created. Creating a weighted graph can include assigning a number of weights to a number of links that connect a number of nodes. For example, a first weight can be assigned, e.g., associated, to a first link. A weight can be a number such as a number between zero and one, for example. Other examples of a weight can be used.

In a number of examples of the present disclosure, a weight for two nodes can be given as:

$$W ( {n}_{i} , {n}_{j} ) = \frac{Freq ( {n}_{i} , {n}_{j} )}{\sqrt{Freq ( {n}_{i} ) \cdot Freq ( {n}_{j} )}} .$$

In the above formula, W(nᵢ,nⱼ) can be a weight assigned to a link between a first node, e.g., nᵢ, and a second node, e.g., nⱼ. Freq(nᵢ) can be given as:

$$Freq ( {n}_{i} ) = {\sum }_{k \text{:} {n}_{i} ∈ {G}_{k}}^{ } Freq ( {G}_{k} ) .$$

That is, Freq(nᵢ) can be a number of times that a node created an event notification and that the event notification was part of a group pattern. For example, Freq(Gₖ) can be a group pattern with a number of event notifications that compose the group pattern and

$${\sum }_{k \text{:} {n}_{i} ∈ {G}_{k}}^{ } Freq ( {G}_{k} )$$

can be a sum of a number of event notifications that were created by node nᵢ and that are included in the group pattern. Freq(nᵢ,nⱼ) can be given as:

$$Freq ( {n}_{i} , {n}_{j} ) = {\sum }_{k \text{:} {n}_{i} ∈ {G}_{k} , {n}_{j} ∈ {G}_{k}}^{ } Freq ( {G}_{k} ) .$$

That is, Freq(nᵢ,nⱼ) can be a number of times that a first node created a first event notification and a second node created a second event notification and that the two event notifications were part of a group pattern Gₖ. For example, Freq(Gₖ) can be a group pattern with a number of event notifications that compose the group pattern Gₖ, and

$${\sum }_{k \text{:} {n}_{i} ∈ {G}_{k} , {n}_{j} ∈ {G}_{k}}^{ } Freq ( {G}_{k} )$$

can be a sum of a number of event notifications that were created by node nᵢ and nⱼ at the same time interval and that are part of a group pattern Gₖ. A weight can be created in a number of manners, the above examples are illustrative and not limiting.

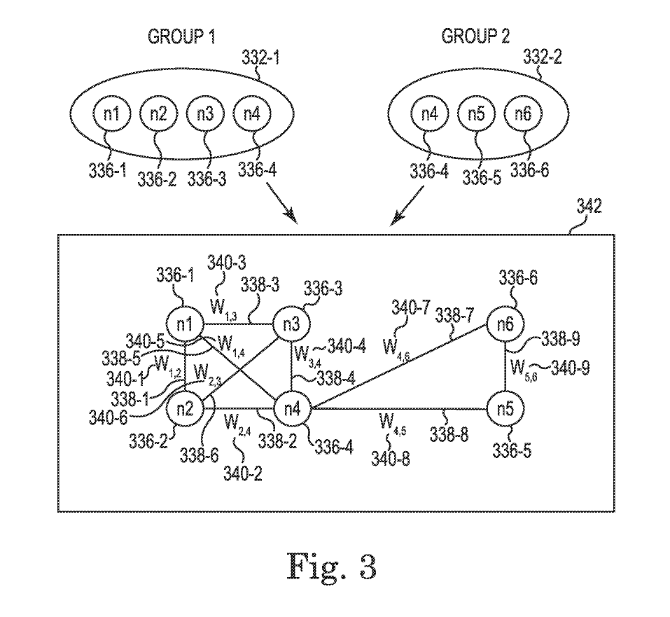

A display of a graph can consist of a number of mediums. For example, a weighted graph can be constructed and displayed through a computer screen and/or on a medium, among others. An example of a weighted graph is given in FIG. 3.

At 228, the weighted graph can be refined. Refining a weighted graph can include, for example, removing a number of links that have a weak associated weight. A number of methods for refining a weighted graph can be employed. A link that represents a relationship between two nodes can have a weak associated weight when the relationship between the two nodes is weak. A relationship between two nodes can be a weak relationship when the correlation between a number of event notifications created by the two nodes is weak. For example, a first number of event notifications that were created by a first node can have a weak correlation with a second number of event notifications that were created by a second node. A correlation between the first number of event notifications and the second number of event notifications can be in relation to a group pattern. That is, a correlation between the first number of event notifications and the second number of event notifications can be weak when comparing to the correlation that the first number of event notifications and the second number of event notifications can have with the other event notifications in a group pattern.

FIG. 3 is a diagram illustrating an example of a weighted graph 342 according to the present disclosure. FIG. 3 illustrates a number of nodes that can be in a number of groups and how the number of nodes can be represented in a weighted graph 342.

A number of groups can include a first group 332-1 and a second group 332-2. The first group 332-1 can include a first node 336-1, a second node 336-2, a third node 336-3, and a fourth node 336-4. The second group 332-2 can include the fourth node 336-4, a fifth node 336-5, and a sixth node 336-6.

A weighted graph 342 can include the nodes in the first group 332-1 and the nodes in the second group 332-2 with a number of associated links and a number of associated weights. For example, the first node 336-1 can be connected to a second node 336-2 by a first link 338-1 that is associated with a first weight 340-1. A first node 336-1 can be connected to a third node 336-3 by a third link 338-3 that is associated with a third weight 340-3. A first node 336-1 can be connected to a fourth node 336-4 through a fifth link 338-5 that is associated with a fifth weight 340-5. A second node 336-2 can be connected to a third node 336-3 through a sixth link 338-6 that is associated with a sixth weight 340-6. A second node 336-2 can be connected to a fourth node 336-4 through a second link 338-2 that is associated with a second weight 340-2. A third node 336-3 can be connected to a fourth node 336-4 through a fourth link 338-4 that is associated with a fourth weight 340-4. A fourth node 336-4 can be connected to a fifth node 336-5 through an eighth link 338-8 that is associated with an eighth weight 340-8. A fourth node 336-4 can be connected to a sixth node 336-6 through a seventh link 338-7 that is associated with a seventh weight 340-7. A fifth node 336-5 can be connected to a sixth node 336-6 through a ninth link 338-9 that is associated with a ninth weight 340-9.

A weighted graph 342 can be displayed before the weighted graph 342 is refined or after the weighted graph 342 is refined. Furthermore, the weighted graph 342 uses a number of symbols to represent nodes and links and weights, the symbols used are illustrative and not limiting.

The weighted graph 342 can assist a user that manages a number of components in finding a number of dependencies. For example, a user can detect that a number of dependencies exist between the nodes in the first group 332-1 and that a number of dependencies exists between the nodes in the second group 332-2. Furthermore, the user can detect that a number of dependencies may exists between the nodes in the first group 332-1 and the second group 332-2 through the fourth node 336-4.

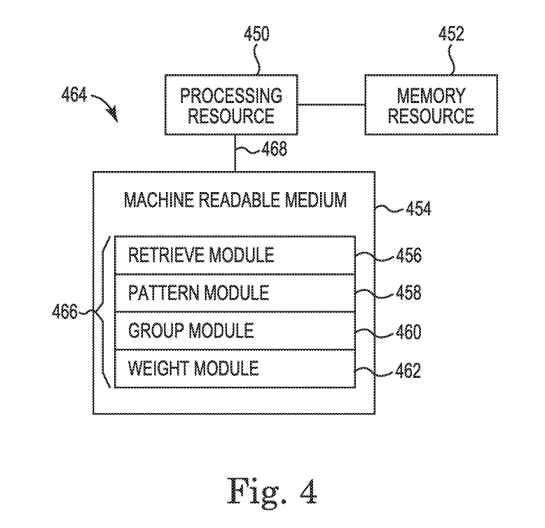

FIG. 4 illustrates an example computing device 464 according to the present disclosure. The computing device 464 can utilize software, hardware, firmware, and/or logic to perform a number of functions.

The computing device 464 can be a combination of hardware and program instructions configured to perform a number of functions. The hardware, for example, can include a number of processing resources 450, machine readable medium (MRM) 454, memory resource 452, etc. The program instructions, e.g., machine-readable instructions (MRI) 466, can include instructions stored on the MRM 454 to implement a desired function, e.g., define relationships.

The processing resources 450 can be in communication with the tangible non-transitory MRM 454 storing the set of MRI 466 executable by a number of the processing resources 450, as described herein. The MRI 466 can also be stored in remote memory managed by a server and represent an installation package that can be downloaded, installed and executed. The computing device 464 can include memory resources 452, and the processing resource 450 can be coupled to the memory resource 452.

Processing resource 450 can execute MRI 466 that can be stored on internal or external non-transitory MRM 454. The processing resource 450 can execute MRI 466 to perform various functions, including the functions described with respect to FIG. 1, FIG. 2, and FIG. 3, among others.

The number of modules 456, 458, 460, and 462 can include MRI 466 that when executed by the processing resource 450 can perform a number of functions. The number of modules 456, 458, 460, and 462 can be sub-modules of other modules. For example, a retrieve module 456 and a pattern module 458 can be sub-modules and/or contained within a single module. Furthermore, the number of modules 456, 458, 460, and 462 can comprise individual modules separate and distinct from one another.

A retrieve module 456 can comprise MRI 466 and can be executed by the processing resource 450 to retrieve a number of event notifications that correspond to a number of nodes. An event notification can be created by a node when the state of the node changes. In a number of examples of the present disclosure, an event notification can be performance related. That is, a node can create an event notification to report the performance of a node. For example, a server, e.g., node, can report a memory usage at a specific time period. An event notification can include a time stamp associated with the event notification. A time stamp can be part of the event notification or the time stamp can be separate from an event notification and an association between the time stamp and the event notification can be created. A number of event notifications can be collected over a time period and can be retrieved. The time period can include discrete time intervals such that a time stamp can fall within one of the time intervals.

A pattern module 458 can comprise MRI 466 and can be executed by the processing resource 450 to create a number of group patterns that correspond to a number of event notifications. A group pattern can include a number of event notifications that were created at the same time and/or substantially the same time. That is, since each event notification has a time stamp associated with it, then a number of time stamps associated with a number of event notifications can be used to determined a group pattern of the number of event notifications. The event notifications can have a substantially similar number of time stamps because a time period over which the number of event notifications are collected can be divided into discrete time intervals. For example, a time period can include a day and a time interval can include an hour such that all of the event notifications that have an associated time stamp that falls within a specific hour can be included in a group pattern.

A group module 460 can comprise MRI 466 and can be executed by the processing resource 450 to group a number of nodes into a number of groups. A number of groups can be created for each of the number of group patterns. That is, a number of nodes that created a number of event notifications that are included in a group pattern can be grouped. A group can define the existence of a number of relationships between a number of nodes in the group.

A weight module 462 can comprise MRI 466 and can be executed by the processing resource 450 to assign number of weights to a number of relationships between a number of nodes. A number of nodes in a group can have a number of relationships. The number of relationships within a group can vary and can have different strengths. A weight can be assigned to a relationship between two nodes to assign a value to the relationship that can be used to compare relationships. For example, a first relationship can have a lower weight than a second relationship. A number weights can be used to determine which relationships are displayed to a user and which relationships are not displayed to the user.

A non-transitory MRM 454, as used herein, can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 454 can be integral or communicatively coupled to a computing device in a wired and/or wireless manner. For example, the non-transitory MRM 454 can be an internal memory, a portable memory, and a portable disk, or a memory associated with another computing resource, e.g., enabling MRIs 466 to be transferred and/or executed across a network such as the Internet.

The MRM 454 can be in communication with the processing resource 450 via a communication path 468. The communication path 468 can be local or remote to a machine, e.g., a computer, associated with the processing resource 450. Examples of a local communication path 468 can include an electronic bus internal to a machine, e.g., a computer, where the MRM 454 is one of volatile, non-volatile, fixed, and/or removable storage medium in communication with the processing resource 450 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 468 can be such that the MRM 454 is remote from a processing resource, e.g., processing resource 450, such as in a network connection between the MRM 454 and the processing resource, e.g., processing resource 450. That is, the communication path 468 can be a network connection. Examples of such a network connection can include local area network (LAN), wide area network (WAN), personal area network (PAN), and the Internet, among others. In such examples, the MRM 454 can be associated with a first computing device and the processing resource 450 can be associated with a second computing device, e.g., a Java® server. For example, a processing resource 450 can be in communication with a MRM 454, wherein the MRM 454 includes a set of instructions and wherein the processing resource 450 is designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for defining relationships between nodes comprising:
retrieving a number of event notifications that correspond to a number of nodes;
defining a number of group patterns that correspond to the number of event notifications;
grouping the number of nodes into a number of groups that correlate with the number of group patterns, the number of groups defining a number of relationships between the number of nodes; and
assigning a number of weights to the number of relationships between the number of nodes, wherein the number of weights are based on a strength of the number of relationships between the number of nodes.

2. The method of claim 1, wherein retrieving the number of event notifications that correspond to the number of nodes includes retrieving a number of abnormal event notifications that originate with the number of nodes.

3. The method of claim 2, wherein retrieving the number of abnormal event notifications includes event notifications that indicate that an error has occurred in the number of nodes.

4. The method of claim 1, wherein the number of relationships between the number of nodes are defined by a number of dependencies between the number of nodes and wherein the number of dependencies correlate with the number of groups.

5. The method of claim 1, wherein defining the number of group patterns that correspond to the number of event notifications includes grouping event notifications based on a time stamp in each of the number of event notifications.

6. A non-transitory machine-readable medium storing instructions for defining relationships executable by a computer to cause the computer to:
retrieve a number of event notifications, the notifications created by a number of nodes;
define a number of group patterns that correspond to the number of event notifications based on a number of time stamps in the number of event notifications;
group the number of nodes into a number of groups that correlate with the number of group patterns, the number of groups defining a number of relationships between the number of nodes;
assign a number of weights to the number of relationships, wherein the weights are based on a strength of the number of relationships between the number of nodes; and
construct a graph with the number of weights, the number of groups, and the number of nodes.

7. The medium of claim 6, wherein the instructions are further executable to place a number of links between the number of nodes in the number of groups, wherein each of the number of group patterns constitutes a group in the number of groups including a subset of the number of nodes whose event notifications are associated with a corresponding group patterns, and wherein the number of links define the number of relationships.

8. The medium of claim 7, wherein the instructions are further executable to assign each of the number of links a corresponding one of the number of weights.

9. The medium of claim 6, wherein the instructions are further executable to determine the strength of the number of relationships between the number of nodes based on the number of event notifications.

10. The medium of claim 9, wherein the instructions executable to construct the graph include instructions executable to construct a visual depiction of the number of relationships between the number of nodes.

11. A system for defining relationships, comprising:
a processing resource in communication with a machine-readable medium, wherein the machine readable medium includes a set of instructions, and wherein the processing resource is designed to execute the set of instructions to:
retrieve a number of event notifications that correspond to a number of nodes;
define a number of group patterns that correspond to the number of event notifications based on a number of time stamps in the number of event notifications;
group the number of nodes into a number of groups that correspond to the number group patterns, and link a set of nodes that are included in each of the number of groups, the number of groups defining a number of relationships between the number of nodes;
assign a number of weights based on a strength of a number of relationships between the number of nodes in the number of group patterns to a number of links that link the set of nodes that are included in each of the number of groups;
construct a graph with the number of weights, the number of group patterns, and the number of nodes, and the number of links; and
refine the graph by removing a subset of links from the graph, wherein the subset of links include links that have an associated weight value that is less than a pruning threshold value.

12. The system of claim 11, wherein the instructions executable to assign the number of weights include instructions executable to calculate the number of weights based on the strength of the number of relationships, wherein a weight reflects a frequency of event notifications.

13. The system of claim 12, wherein the frequency of event notifications is relative to each of the number of groups, and wherein the frequency of event notifications contributes to the strength of the number of relationships.

14. The system of claim 12, wherein the instructions executable to refine the graph include instructions executable to correlate the pruning threshold with the frequency of event notifications.

15. The system of claim 12, wherein the instructions executable to refine the graph include instructions executable to remove links from each of the number of groups that do not share many neighbors with other links in each of the number of groups, wherein links in a group are neighbors.
